(19) United States
(12) Patent Application Publication
(10) Pub. No.: US 2002/0178819 A1
(43) Pub. Date: Dec. 5, 2002

(54) Giant magneto-impedance (GMI) spin rate sensor

(76) Inventor: Mark Clymer, Old Mystic, CT (US)

Correspondence Address: McCormick, Paulding & Huber, City Place II, 185 Asylum Street, Hartford, CT, 06103-3402, US

(21) Appl. No.: 10/035,627

(22) Filed: Nov. 1, 2001

Related U.S. Application Data
(60) Provisional application No. 60/245,247, filed on Nov. 2, 2000.

(51) Int. Cl. G01P 3/44

(52) U.S. Cl. 73/514.39

(57) ABSTRACT

A GMI sensor comprised of a GMI fiber for determining a spin rate of a rotating body in which the GMI fiber is fixed relative to the body as the body spins within an external magnetic field is presented. The sensor comprises a GMI fiber having multiple axes of sensitivity with at least two of the axes being oriented one to the other such that the segments act independently, but employing a single conditioning circuit.

### CROSS-REFERENCE

This application claims priority to Provisional Application Serial No. 60/245,247 to Mark Clymer entitled “Multi-Axis Angular Rate Sensor Using Giant Magnetoimpedance (GMI) Fiber” filed Nov. 2, 2000, which is currently pending, and the entire disclosure of which is incorporated herein by reference.

### FIELD OF THE INVENTION

The present invention relates generally to sensors and more specifically, to a sensor for determining the spin rate of a rotating body within an external magnetic field, such as the magnetic field of the earth.

### BACKGROUND OF THE INVENTION

In military applications, it is generally agreed that the number of revolutions that a spinning projectile makes as it travels along its trajectory is an accurate indicator of the linear distance traveled by the projectile, as the distance that a projectile will travel linearly per revolution is constant. Theoretical analysis shows that a counter capable of recording the number of revolutions made by a spinning projectile has the potential to measure the range of a projectile better than a time counter. This is due to the fact that time must be combined with muzzle velocity to obtain range, and muzzle velocity varies from projectile to projectile, i.e. round-to-round. On the other hand, the number of revolutions made by a spinning projectile during flight is independent of the muzzle velocity.

The advantages of developing and implementing spin-counting technology are several. For example, fusing of the projectile will be inherently easier and more accurate. Currently, a fire control system associated with a weapon firing the projectile needs to adjust the fuse setting within the projectile to account for round-to-round muzzle velocity variations. If spin-counting technology were employed, the fire control system could be simplified as round-to-round muzzle velocity variations would no longer have to be taken into account. Simplification of fire control systems results in an overall easier to maintain, more reliable, more cost effective and above all more accurate.

Previous spin sensors, i.e. sensors capable of outputting a signal indicative of a revolution of a body, have employed magnetically sensitive coils as the signal generator. As the coil rotates about the spin axis of the projectile, a voltage is produced across the coil proportional to the rate of change of the flux density with time, i.e. v=−dφ/dt, which can be used to count rotations of the projectile. A drawback to this approach is that the size of the coils needed for certain applications are the size of the coil. The faster the projectile spins the smaller the coil can be. Slow spinning projectiles, such as a KE anti-tank round, require relatively larger coils, i.e. coils with more windings or a larger diameter, than faster spinning rounds.

Coils have recently been replaced by giant magnetoimpedance (GMI) material in fiber form. For one example of such a spin sensor see U.S. patent application Ser. No. 09/518,651 entitled “Giant Magneto-Impedance (GMI) Spin Rate Sensor” that is assigned to the same party as the present application, namely Sardis Technologies LLC of Mystic, Conn., and the disclosure of which is incorporated herein in its entirety. GMI fibers exhibit a strong dependence of a.c. (alternating current) impedance on the applied magnetic field when driven by a sufficiently high frequency current and the voltage across the GMI fiber will vary as it is rotated in the applied magnetic field, e.g. the magnetic field of the earth.

Single coil spin sensors, however, suffer from a “null zone” problem. A coil, or GMI fiber, has an axis of sensitivity. When the axis of sensitivity is oriented perpendicular to the magnetic flux vector of the earth, it will not respond, i.e. in the case of a coil no voltage will be induced in the coil, as it rotates; thus the number of rotations of the projectile are not counted. Depending upon the size of the coil, the “null zone” can extend over several degrees from parallel. To avoid null zone issues, the spin sensor can employ multiple coils wherein the axis of sensitivity of the coils, e.g. at least two coils, are not parallel. However additional coils require additional power and signal conditioning circuitry that increase the overall size of the spin sensor in some cases to a point where the spin sensor will no longer fit into certain projectiles.

Based on the foregoing, it is the general object of the present invention to provide an apparatus that overcomes the problems and drawbacks of the prior art.

### SUMMARY OF THE INVENTION

The present invention is a giant magnetoimpedance (GMI) fiber for use in a fixed magnetic spin sensor, i.e. a sensor that reacts as it is moved through a magnetic field, within a body rotating in a magnetic field wherein the GMI fiber is fixed in position relative to the rotating body, i.e. the GMI fiber does not move relative to the body but rotates as a result of the body spinning about a spin axis. More specifically, the GMI fiber, which could be within a sensor, is folded to create at least two segments wherein each segment has an axis of sensitivity and at least two axes of sensitivity are oriented one to the other such that the segments act independently.

The folded GMI fiber can be used to create a GMI sensor, i.e. a fixed magnetic spin sensor, that has multiple independent axes and is thus capable of generating an output signal indicative of the rotation of the body in which the GMI fiber is fixed regardless of the orientation of the body, e.g. projectile, to the magnetic field through which it is rotating. For the various segments to act independently, the segments must be oriented one to the other such that when spinning about an axis each segment cuts the flux lines of the magnetic field in which the body is rotating differently. For example, if one segment is located in a plane perpendicular to the spin axis of the body, the second segment cannot also be located in that plane, i.e. it must be located at some angle to that plane. It is understood that for a GMI fiber to work properly, it cannot be coincident with the spin axis of the body.

The GMI sensor is comprised of an oscillator connected to a GMI module, which includes the GMI fiber in series with a resistor wherein the resistor is interposed between the GMI fiber and the oscillator. There is a signal pickup between the resistor and the GMI fiber.

In the present invention, an alternating square wave drive signal, which is zero or positive, is generated by a properly configured oscillator. The drive signal is then conditioned to provide a pure alternating drive signal, i.e. all direct current bias removed. The drive signal then enters the GMI module. When the body within which the GMI fiber is fixed is rotated, the alternating drive signal is modified at the signal pickup based on the change in impedance within the GMI fiber. The signal at the signal pickup point is still however alternating. This signal is indicative of the rotation of the body.

The GMI sensor can additionally include a signal circuit connected to the signal pickup for producing a signal that can be used by an electrical appliance in which the GMI sensor is installed that is indicative of the spin rate. In the preferred embodiment, a difference amplifier is used to produce an alternating analog signal. The difference amplifier obtains its bias signal from the oscillator. By obtaining the bias signal for the difference amplifier from the oscillator, the basing is dynamic helping to maintain signal switch point and output tracking as the oscillator output varies and the impedance changes with outside factors such as temperature and humidity.

As an option, and as shown in the preferred embodiment, a comparator can be coupled to the difference amplifier for converting the alternating signal to a digital signal to provide multiple output signal forms. Just as the analog alternating signal is indicative of the spin rate, so too is the digital signal. The comparator is also biased, receiving its bias signal from the oscillator also.

As a refinement to the invention, low pass filters can be incorporated. A low pass filter can be in the basing circuit of the difference amplifier and the comparator as well as in the signal circuit between the signal pickup and the difference amplifier.

### BRIEF DESCRIPTION OF THE DRAWINGS

FIG. 1 is a schematic diagram of a GMI sensor in accordance with the present invention.

FIG. 2 is a schematic diagram of a GMI fiber in a rotating body.

### DETAILED DESCRIPTION OF THE PREFERRED EMBODIMENT

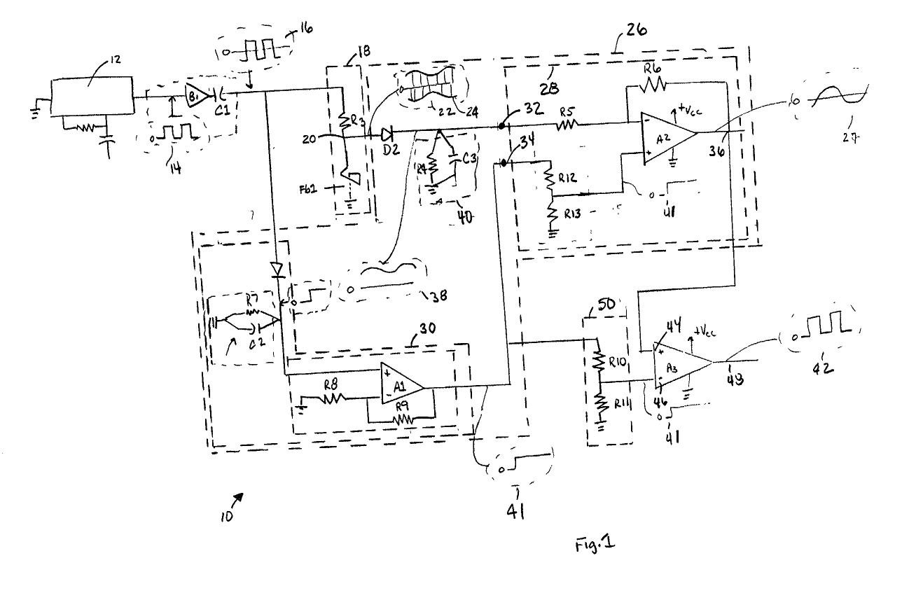

Referring to FIG. 1, an embodiment of a GMI sensor generally referred to by reference number 10 is comprised of a oscillator 12 which generates an alternating signal 14 which is conditioned by a buffer B1, and a capacitor C1 to provide a pure alternating drive signal 16, i.e. all direct current bias removed. A GMI module 18 comprising a resistor R3 and a GMI fiber Fb1 in series has the other end of the resistor R3 connected to the capacitor C1 and the other end of the GMI fiber Fb1 connected to ground. Signal pickup 20 is positioned between the resistor R3 and the GMI fiber Fb1. The GMI fiber Fb1 is biased with a permanent magnet (not shown) along its length to provide sensing polarity.

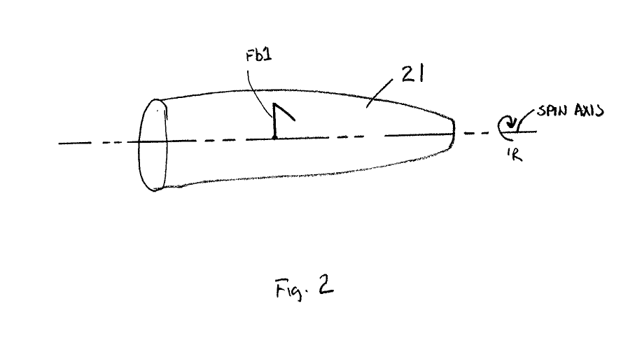

As shown in FIG. 2, the GMI fiber Fb1 is disposed in fixed relation to a rotating body 21 having a rotation R about a spin axis. Continuing with FIG. 1, as the body rotates the impedance of the GMI fiber Fb1 is modulated by a external magnetic field (not shown) to provide an amplitude modulated drive signal 22 at the signal pickup 20. The amplitude modulations of amplitude modulate drive signal 22 define a data signal 24 with a frequency indicative of the spin rate of the rotating body.

A signal circuit 26 (shown within dotted lines) is connected to the signal pickup 20. The signal circuit 26 processes the modulated drive signal 22 to provide an analog output signal 27 that is indicative of the spin rate of the rotating body.

The signal circuit 26 includes a rectifier D2, i.e. a diode, a difference amplifier 28, and a bias signal 30. The difference amplifier 28 has an inverting terminal 32, a non-inverting terminal 34, and an output terminal 36. The rectifier D2 is deposed between the signal pickup 20 and the inverting terminal 32 such that the modulated drive signal 22 is converted into rectified modulated signal 38. The rectified modulated signal 38 is then passed through the difference amplifier 28 to created analog output signal 27. An optional low-pass filter 40 is also provided interposed between the rectifier D2 and the inverting terminal 32. Connected to the non-inverting terminal 34 is the bias signal 30 that is in turn connected to oscillator 12 at a point where the pure alternating drive signal 16 can be obtained. The bias signal 30 converts pure alternating drive signal 16 into a direct signal 41. It is direct signal 41 that cooperates with the data signal 24 within the difference amplifier 28 to create the analog output signal 27.

An optional comparator A3 is provided to convert the analog signal 26 to a digital signal 42. The comparator A3 has a non-inverting terminal 44, an inverting terminal 46, and an output terminal 48. The output terminal 36 of the difference amplifier 28 is connected to the non-inverting terminal 44 of the comparator A3. The inverting terminal 46 of the comparator A3 is connected to a comparator bias 50 that is in turn connected to bias signal 30. Within the comparator A3 the direct signal 40 cooperates with the analog output signal 27 to create the digital output signal 42.

The present invention was designed using the phenomenon of giant magneto-impedance (GMI), which is known and found in fibers comprised of materials having a high magnetic permeability, e.g. cobalt-rich fibers. In the present invention, the GMI fiber was made of a single length of fiber of giant magnetoimpedance material, approximately 10 mm in total length, formed into at least two segments, with segments possibly perpendicular one to the other. Any number of segments could be created.

As an example of the invention, a small high-frequency current of approximately 24 MHz is applied through a GMI fiber having a diameter of 5 μm, and a length of approximately 5 mm, which generates a fiber impedance with resistive and inductive components due to the skin effect and the circumferential field. The skin effect is defined as a non-uniform distribution of electric current over the cross-section of a conductor when carrying an alternating current. The current density is greater at the surface of the conductor than at its center. This is due to electromagnetic (inductive) effects and becomes more pronounced as the frequency of the current is increased. The amplitude of induced voltage between the ends of the fiber changes for an external small DC field, such as is caused by the magnetic field of the earth, e.g., applied in parallel with the fiber axis. This is similar to an impedance magnetometer that is used for measuring local variations of a magnetic field by measuring the change in impedance of a nickel-iron wire of high permeability. The change in impedance is caused by the axial component of the field in which the wire is placed. The current is opposed by the capacitance and inductance of the circuit in addition to the resistance. The total opposition to current flow is the impedance, which is given by the ratio of the voltage to the current in the circuit.

While preferred embodiments have been shown and described, various modifications and substitutions may be made thereto without departing from the spirit and scope of the invention. In particular, the signal circuit can be of almost any design compatible with the single requirements of an electrical appliance in which the sensor is installed. Accordingly, it is to be understood that the present invention has been described by way of illustration and not limitation.

What is claimed is:

1. A multi-axis sensor comprising:
a fiber including a GMI substance therein, the fiber being folded into at least two sections, each section having an axis of sensitivity, at least two axes of sensitivity being oriented one to the other such that the segments act independently when rotating about a common axis.

2. A method of using a giant magnetoimpedance material for a fixed magnetic spin sensor element within a rotating body, the method comprising:
selecting a fiber of giant magnetoimpedance material;
folding the fiber creating at least two sections, each section having an axis of sensitivity, at least two axes of sensitivity being oriented one to the other such that the segments act independently;
and fixing the sensor in the body.

3. The method of claim 2 wherein in the fiber comprises cobalt.

4. The method of claim 2 wherein in the step of folding the fiber the folds are at approximately right angles.

5. A GMI sensor for determining the spin rate of a rotating body within
an external magnetic field, the sensor comprising;
an oscillator generating an AC drive signal;
a GMI module including a series circuit of fixed resistance connected to a GMI fiber fixedly disposed within the body, the series circuit fixed resistance end connected to the oscillator and the other end to ground, the GMI fiber being bent into a plurality of segments, each segment having an axis of sensitivity, at least two of the segments axes of sensitivity being oriented one to the other such that the segments act independently; and
a signal pickup located between the fixed resistance and the GMI fiber.

6. The GMI sensor of claim 5 further including a signal circuit having an amplifier and a rectifier, the rectifier connected between the signal pickup and amplifier.

7. The GMI sensor of claim 6 further comprising a low pass filter between the rectifier and the amplifier.

8. The GMI sensor of claim 6 wherein the amplifier is a difference amplifier having an inverting terminal, a non-inverting terminal and an output terminal wherein a bias is connected to the non-inverting terminal and the rectifier is connected between the signal pickup and the inverting terminal.

9. The GMI sensor of claim 8 wherein the signal circuit has a comparator with an inverting and a non-inverting terminal, the output terminal of the difference amplifier connected to the non-inverting terminal of the comparator, and wherein a comparator bias is connected between the inverting terminal of the comparator.

10. The GMI sensor of claim 9 wherein the non-inverting terminal of the difference amplifier and comparator bias are connected to the oscillator through a rectifier.

11. The GMI sensor of claim 10 further comprising a low pass filter interposed between the rectifier and the non-intervening terminal of the difference amplifier and comparator bias.

12. The GMI sensor of claim 5 further including a single signal circuit for generating a signal indicative of the spin rate of the body.

13. The GMI sensor of claim 13 wherein the single signal circuit has multiple output signals.
